(19) United States
(12) Patent Application Publication
(10) Pub. No.: US 2007/0169084 A1
(43) Pub. Date: Jul. 19, 2007

(54) Persistent maintenance of customization data on computing devices

(76) Inventors: Davis W. Frank, Burlingame, CA (US); Ezekiel Sanborn De Asis, Santa Clara, CA (US); Rajan Ranga, Palo Alto, CA (US); Mark Eastwood, Little Lyth Shrewsbury (GB)

Correspondence Address: SHEMWELL MAHAMEDI LLP, 4880 STEVENS CREEK BOULEVARD, SUITE 201, SAN JOSE, CA, 95129, US

(21) Appl. No.: 11/302,313

(22) Filed: Dec. 12, 2005

(51) Int. Cl. G06F 9/44

(52) U.S. Cl. 717/168

(57) ABSTRACT

In a computing device, customization data is persistently maintained independent of the device's operating system. Customization data may stored in a computing device's persistent memory (or ROM or equivalent memory component), along with but independent of the operating system. When the computing device is first initialized, or when the computing device is initialized immediately after a hard-reset event, the customization data is not lost.

### TECHNICAL FIELD

The disclosed embodiments relate generally to the field of data management on computing devices. More particularly, the disclosed embodiments relate to the persistent maintenance of customization data on computing devices.

### BACKGROUND

There are numerous kinds of computing devices that are manufactured to have a specific default or factory setting state. Typically, the default or factory state can be restored should the device require repair or otherwise undergo a reset or other event in which data loss occur. At minimum, operating a computing device from the default state returns the operating system, so that the computing device is operable. In many cases, the default state of a computing device carries applications and/or data that are loaded onto the device prior to use or sale of the device.

The applications and data stored onto a computing device as part of the devices operational state following a data loss event is sometimes customized. The most frequent example of such customization is with cellular phones. Cellular phones are usually vended through wireless carriers and providers, who employs soft branding and specific application data to conform any generic hardware device into one that is specific for the carrier.

However, customizing a computing device for its hard reset state is an expensive and cumbersome process. Such customizations normally require the device manufacturer to “crack the ROM”, meaning the device manufacturer must access a portion of persistent memory where the operating system resides. This portion of memory is normally sealed. Once this is done, the device needs to be recertified for its operating system and possibly other standards or protocols.

In order to avoid the costs and labor involved in re-certifying computing devices, one alternative approach has been to enable device customization after the device has been made operational. But the party that wishes for the customization to be present (e.g. the wireless carrier) loses control over the customization. For example, the end user may decide not to perform steps that result in customization, or develop a work-around to the customization. To provide a more specific example, portable computing devices, such as combination telephony/messaging devices, can be synchronized with larger computer systems. Customization may be performed at that time of initial synchronization. However, the end user may always decide not to synchronize the device, or configure the synchronization process so that customization does not take place.

Also, in the case of cellular telephony devices, hard resets are not uncommon over the life of any the particular device. Customization data provided for the device in the operational state may be lost once a given device is hard reset after it has been in use.

### BRIEF DESCRIPTION OF THE DRAWINGS

FIG. 1 is a simplified block diagram of a memory component, under an embodiment.

FIG. 2A and FIG. 2B illustrate a configuration for a memory component in a hard-reset state and in an operational state respectively, according to an embodiment of the invention.

FIG. 3A-FIG. 3C illustrate a memory architecture for use with a computing device, under an embodiment of the invention.

FIG. 4 illustrates a method in which customization data may be persistently loaded and used, under one embodiment of the invention.

FIG. 5 illustrates a system for implementing an embodiment such as shown by FIG. 4, according to one or more embodiments of the invention.

FIG. 6 illustrates a system by which customization data may be selected, specified and even created for use in customizing blank (un-customized) devices.

FIG. 7 illustrates a graphic user-interface tool for enabling design and creation of customization data sets, under an embodiment of the invention.

FIG. 8 illustrates a simplified block diagram for use with one or more embodiments of the invention.

### DETAILED DESCRIPTION

Embodiments of the invention enable a computing device to persistently maintain customization data independent of its operating system. According to one embodiment, customization data is stored in a computing device's ROM (or equivalent memory component), along with but independent of the operating system. When the computing device is first initialized, or when the computing device is initialized immediately after a hard-reset event, the customization data is not lost.

Additionally, an embodiment provides that the amount of memory reserved for customization data is based in part on the size of the customization data. Thus, unused memory may be avoided while reserving memory for the customization data, even when the customization data is provided independent of the operating system.

As will be described, embodiments enable customization data to be loaded separately from the operating system when the devices are manufactured, or otherwise being provided with logic and software. During the manufacturing process, customizations may be made to a particular class of devices without “cracking the ROM” or otherwise accessing the operating system. This enables the class of devices to be customized without requiring recertification of the ROM and/or operating system. Since re-certification of the ROM and operating system can be avoided, customization data may be implemented much more cost effectively, while at the same time reducing the amount of time to customize a class of computing devices to market. Additionally, customizations may be made to relatively small classes of computing devices, something which would otherwise not be cost-effective.

According to another embodiment, a computing device may be customized from a hard-reset state. Upon initialization of the computing device from a hard-reset state, a determination is made of a size of a portion of a persistent memory that is to be formatted. The size may be based on an amount of customization data that is stored in a region of the persistent memory that contains the portion to be formatted. The region of the persistent memory is independent of another persistent memory region where the operating system is stored. The portion of the second memory is formatted without affecting the customization data.

In one embodiment, a value may be stored in the persistent memory region where the operating system is stored. The value may be based on the size of the customization data. The value may be used to determine a size of the portion of memory that is to be formatted. According to another embodiment, a component for a computing device includes a persistent memory. The persistent memory is configured to store and preserve data when the computing device is in a hard-reset state. Under one embodiment, data stored in the persistent memory in the hard-reset state corresponds to an operating system and customization data. According to an embodiment, a first logic delineates a first region of the persistent memory where the operating system is stored from a second region in the memory where the customization data is stored. As a result, the customization data is retrievable from the second region without retrieving data from the first region. A second logic may also be provided that reserves a location of the second region where the customization data is stored. This location may be based on a size of the customization data.

According to another embodiment, the second logic may also indicate the location of the customization data outside of the first region. At least a portion of the second region excluding the customization data is capable of being formatted when a computing device containing the memory component is initialized from the hard-reset state.

The expression “persistent” in the context of memory (e.g. “persistently stored” or “persistent memory”) is intended to mean memory that can provide data that it stores for as long as that memory is not made defective, provided that such data is not erased by a processor operation performed operation. For example, persistent memory is capable of retaining data in the absence of power.

The term “customization data” is meant to mean any data that, when implemented on a set of one or more devices, distinguish those devices from other devices that would, but for the customization data, be identical.

As used herein, the term “hard-reset state” is meant to mean a state in which no data is held on the computing device but for data provided by the manufacturer/supplier (e.g. “factory settings”) or otherwise through one or more embodiments described herein. One example of a hard-reset state is the state of an out-of-the-box device, prior to its first use. Another example of a hard-reset state is a state following an operation or series of operations that turn a device back to its “factory settings”. There are some computing devices, such as recent personal digital assistants (PDAs), where a hard-reset protocol is provided that can be used by the user to restore the device to factory settings, for purpose of trouble-shooting or reselling the device.

The term logic may mean data, or data executable by a processor as instructions. The terms “first logic” and “second logic” may actually be part of the same code, instruction or even data value, although they may also be separate.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented through use of modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

FIG. 1 is a simplified block diagram of a memory component, under an embodiment. A memory component 100 may be provided for use with other memory components (not shown in FIG. 1). The memory component 100 persistently holds data critical to a computing device's operation when the computing device is initialized from a hard-reset state. In one implementation, the memory component 100 is a “ROM” component, holding data critical to the computing device's operation, including an operating system 110 or BIOS data (not shown). As part of or in addition to the operating system, one or more applications that are packaged or otherwise included with the operating system may be included within the same partition or region of the operating system 100. For example, core applications for a particular operating system may be included within the partition of the operating system. As a specific example, PALM OS (manufactured by ACCESS INC) includes certain personal information management applications, such as a Contacts Application, as a core application. The operating system 110 may be in a wrapped state when it resides in the memory component 100. A specific type of persistent memory component contemplated for use with one or more embodiments is a Flash memory component, which enables data to be written to the component in blocks, rather on a byte basis. Flash memory is commonly used in small or thin computing devices, such as cellular telephony devices and messaging devices. A specific type of Flash memory that is persistent and typically used to hold the operating system is a NAND Flash memory component.

In an embodiment such as shown by FIG. 1, a partition 120 in the memory component 100 separates a first region 122 where the operating system 110 is provided from a second region 124. A range of memory addresses may be associated with each of the first region 122 and second region 124 of memory component 110. The partition 120 may be logical in nature, in that it is formed and maintained by low-level code executed by processing resources (not shown) on the computing device. In one implementation, memory component 100 is part of a memory architecture where the second region 124 provides a store for storing applications and application data from a volatile memory component (e.g. device RAM). For example, when the computing device is in an operational state, applications and application data running on the device are stored in a portion of the RAM, and then backed up into the file format established on the unused portion of the Flash memory component. In the event of a software reset (sometimes called a “soft reset”), the Flash memory component is unaffected, and the RAM component may be restored using the backed up data.

According to an embodiment, the memory component 100 is provided customization data 130. Customization data 130 is data that configures a particular computing device with software and/or data, so that the device is customized to belong to a class, group or even individual. Under one implementation, the computing device 130 is a mobile computing device, such as a cellular telephony device, and the customization data 130 conforms such mobile computing devices (e.g. “phones”) into a class of devices for a particular carrier that is to offer those phones for sale and use. For example, a manufacturer may make a large quantity of devices that all have a particular hardware and software design (including operating system), and the customization data 130 may customize a portion of the devices to have functionality, data and/or software generated look and feel that is specific to a wireless carrier. In this case, the customization data 130 conforms devices to a class consisting of devices made for a particular carrier. More specific examples of customization data 130 for a wireless carrier include (i) images for soft branding the cellular carrier with the device, (ii) default applications (e.g. wireless carrier store locator) for the carrier, (iii) a set of contact records for contacting the supplier/wireless carrier, (iv) a set of default bookmarks, (v) images for wall paper, (vi) a default ring tone, and (vii) default email settings to enable the device to retrieve email messages from a user's account.

In one embodiment, the customization data 130 is provided in the second region 124, so that the customization data 130 is independent of the first region 122 of the memory component where the operating system 110 is provided. As such, the customization data 130 may be stored in the memory component 100 independently of the presence of the operating system 110 (as well as other applications (e.g. core applications) and data stored therein). In particular, the customization data 130 may be stored after the operating system 110 is loaded, partitioned and sealed. Thus, if the operating system 110 is certified, the addition of customization data 130, or its subsequent modification thereto, does not require the operating system to be re-opened or subject to another certification. For example, a computing device may be manufactured, with the operating system 110 sealed and certified, then provided customization data in a subsequent manufacturing step to enable a vendor or interested party in selling and/or using the computing device. As another example, manufactured devices, or devices in use by users, may be updated as to customization data 130, without the need to alter the operating system 110 or access the region in memory where the operating system is maintained. For example, when a mobile telephony device reaches its the end of its product life-cycles, existing devices that have been customized for a particular carrier may be re-customized by overwriting or updating existing customization data 130, so that the devices can be marketed by another carrier who has need for the older devices. Still further, when devices are returned, they may be re-customized (through updates or overwrites to the customization data 130) so as to serve as refurbished devices for a different carrier. Either of these functions may be at the manufacturing level quickly and cost-effectively, with no requirement to “Crack the ROM” or re-certify the operating system 110. Furthermore, software tools or programs may enable entities other than the manufacturer to configure a device of classes of devices with customization data. In one embodiment, a reseller or refurbisher may use a software tool to load the customization data 130. In another embodiment, a user may load the customization data by downloading a file on to the device that is to be customized (or onto a computer that synchronizes with the device to be customized), then entering customization data and having that customization data affect the device.

In one implementation, memory component 100 may correspond to a NAND Flash memory module, typically used by more sophisticated cellular telephony devices. An example of operating system 110 is PALM OS, or WINDOWS MOBILE manufactured by the MICROSOFT CORP. The memory component 100 may form just a part of an overall memory architecture on a computing device. According to one device implementation, volatile memory is used as RAM and executes an unwrapped version of the operating system 110. On initialization from a hard-reset state, the second region 124 of the memory component 100 is formatted to backup the RAM and to provide a directory or other memory file format. The second region 124 may have any range of memory addresses outside of the first region 122. The process of structuring the second region 124 deletes any existing data that is in the portion being formatted. The customization data 130 is situated in the second region 124 so that when structuring occurs, the portion of the second region carrying the customization data is unaffected. In this way, the customization data 130 remains persistent from the hard-reset state.

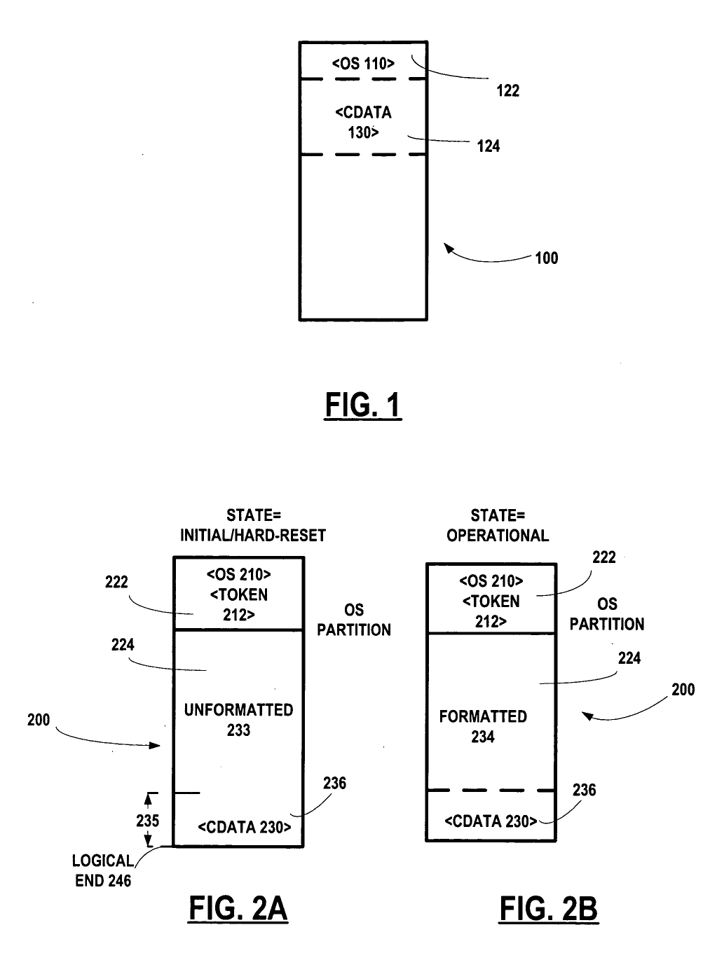

FIG. 2A and FIG. 2B illustrate a configuration for a memory component in a hard-reset state and in an operational state respectively, according to an embodiment of the invention. In FIG. 2A and FIG. 2B, a memory component 200 may correspond to a Flash memory component (e.g. NAND Flash) holding the operating system 210 for the computing devices on which the memory component resides. The memory component 200 may be part of the overall memory architecture in, for example, a cellular telephony/messaging device.

FIG. 2A illustrates the configuration of the memory component 200 when the computing device is in a hard-reset state. The hard-reset state may correspond to a state in which the computing device and the memory component 200 have never been used, or alternatively, a state of the computing device and memory component just after a hard-reset event, where any data that was added to the device after it was put in use is erased. The memory component 200 is partitioned into a first region 222 (corresponding to a first range of memory addresses) and a second region 224 (corresponding to a second range of memory addresses). The first region 222 contains data corresponding to the operating system 210 and a token 212. The second region 224 includes the customization data 230. As will be explained, the token 212 may include or correspond to a value that enables identification of the address range for the portion of memory in the second region 224 where the customization data 230 is provided.

In one embodiment, customization data 230 is written to an address range that has at least one known address. The known address acts as a reference point for locating the customization data 230 apart from a remainder the second region 224 of the memory component 200. In one simple case, where for example, memory component 200 has only one partition, this address range that is to be provided the customization data 230 may include the logical end 246 of the memory component 220. The logical end 246 of the memory component 220 is where the last memory address range is provided, and it may form the reference point from which customization data is written up in address range. In the hard-reset state, the portion of the second region 224 that does not hold the customization data 130 is not formatted. Thus, an address range 235 at a bottom of the memory component 230 provides the reference point for the customization data 230, and this address range is in the second region 224, so as to be independent of the first region 222 where the operating system 210 resides. A portion 236 may correspond to the address range 235, defining the location of the customization data 230. In an embodiment provided with FIG. 2A, an unformatted portion 233 is the remainder of the second region 224 less the portion 236 defined by the address range 235.

In one embodiment, the token 212 carries a value corresponding to a size of the customization data 230. Since the customization data 230 is written from a known address (e.g. the bottom or logical end 246 of the memory component 230), the address range 235 for where the customization data is stored (portion 236) is known. This enables a subsequent process to format the second region 224 without affecting the customization data 230. Such a subsequent process may be invoked when the device is initiated from the hard-reset state. In an embodiment shown, the size of the portion of the second region 224 that is to be formatted (i.e. the unformatted portion 233, or substantial portions thereof) is dependent on the size of the customization data 230.

According to an embodiment in which the customization data 230 is provided at the bottom of the memory component 200, the second region 224 may be formatted by specifying a size of the memory to be formatted in the second region 224. Specifically, the size of the memory that is to be reformatted may correspond to a difference in (i) the total amount of memory in the memory component, less (ii) the amount of memory in the first region 222 where the operating system is provided, less (iii) the value of the token 212 (i.e. the size of the customization data 230). In one implementation, this determination may be made by determining the free memory in the memory component less the value represented by the token 212. This results in the address range 235 being unaffected by the structuring process for the remainder portion of the second region 224.

In FIG. 2B, memory component 200 is shown when the computing device is in an operational state. In this state, the device has been initialized (e.g. turned on for the first time). The free memory provided by the second region 224 of memory component 200 has a format mounted on it (e.g. directory) as part of an initialization process. Under one implementation, the formatted portion 234 of the memory component 100 provides back up memory space to enable device performance after soft-reset events. The creation and presence of the formatted portion 234 does not affect the portion 236 where the customization data 230 is provided. The customization data 230 is then available for use by the applications and/or operating system when the device is in the operational state.

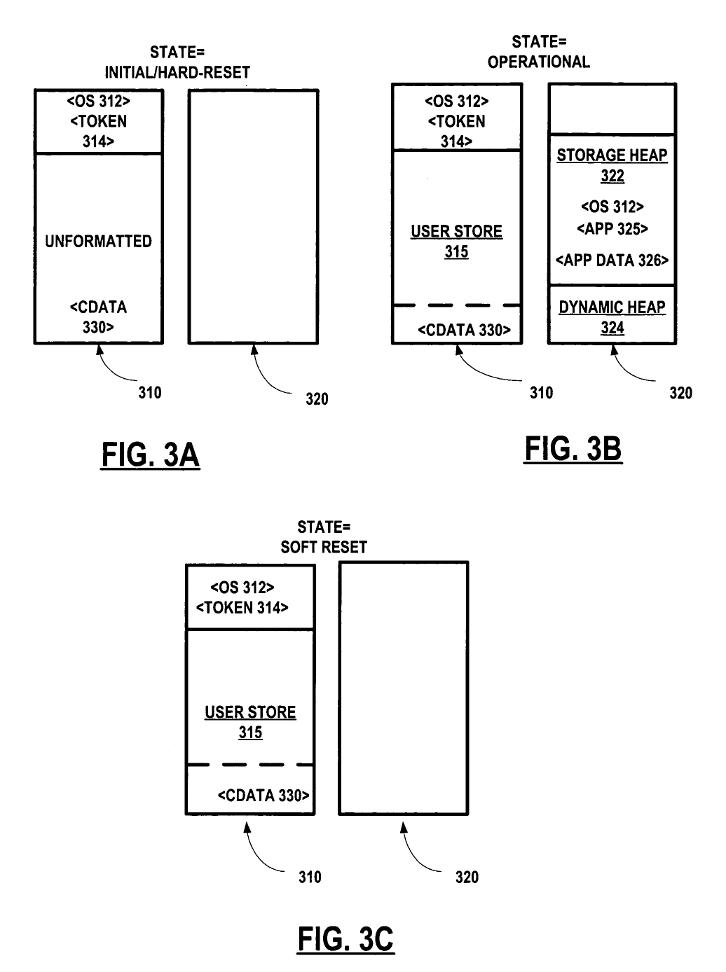

FIG. 3A-FIG. 3C illustrate a memory architecture for use with a computing device, under an embodiment of the invention. According to an embodiment shown, a persistent memory component 310 and a RAM component 320 may cooperate together to enable data preservation after soft-reset events, while at the same time providing customizations upon any initialization from a hard-reset or factory-setting state.

In FIG. 3A, the memory architecture is in the hard-reset state. The persistent memory component 310 includes the operating system 312 and the token 314. A set of customization data 330 is written to an address range having a known reference address (e.g. the bottom of the memory component). As mentioned previously, the token 314 may represent the size of the customization data 330. In the hard-reset state, the persistent memory component 310 persistently holds the operating system 312 and the token 314 in a region partitioned from the remainder of that component. The customization data 330 is also contained in a region of memory component 310 that is otherwise not formatted. The RAM component 320 is without data.

FIG. 3B shows the memory architecture in the operational state, following initialization from the hard-reset sate, according to an embodiment of the invention. In FIG. 3B, the persistent memory component 310 is altered in that the free range of that component outside of the partition for the operating system is formatted to serve a purpose. In the implementation shown, for example, the persistent memory component 310 is formatted to provide a user store 315. The RAM component 320 may be formatted to include, among other elements, a storage heap 322 and a dynamic heap 324. The storage heap 322 may store applications 325 and application data 326 that is semi-persistent, meaning it is present when the device is turned on or off. The applications 325 and the application data 326 are backed up in the user store 315 of the persistent memory component 310 when the device is in the operational state.

FIG. 3C shows the memory architecture immediately after a soft-reset event, under an embodiment of the invention. The RAM component 320 has some or all of its data erased. The user store 315 may be used to restore applications 325 and application data 326 following the soft-reset.

In the states shown by FIG. 3B and FIG. 3C, customization data 330 may include data, code, applications and settings that are used by the operating system and/or other applications to customize the computing device. For example, in the operational state, customization data 330 may include contact records that are made available through use of a contact application. With regard to FIG. 3C, the customization data 330 may include an image that brands the device when it is restarting from the soft-reset state.

As the aforementioned embodiments illustrate, the persistent memory of a computing device may be provided an additional logical partition for the customization data to be preserved in a hard-reset state. This partition may be dynamic, in that it fits the size of the customization data. More generally, the dynamic partition formed may be at least partially dependent in size on the amount of customization data present. This is in contrast to providing the customization data in a partition that is of a uniform size, regardless of the amount of customization data present. In the latter case, more unused memory results in the persistent memory component.

Customization Data Loading

In order to persistently store customization data in a computing device, a process needs to be implemented by which the customization data can be written to a persistent memory element of a memory architecture. Numerous techniques exist to write customization data into persistent memory.

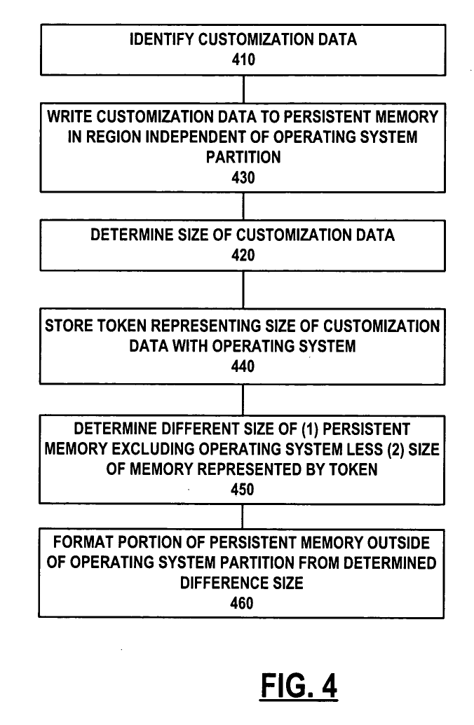

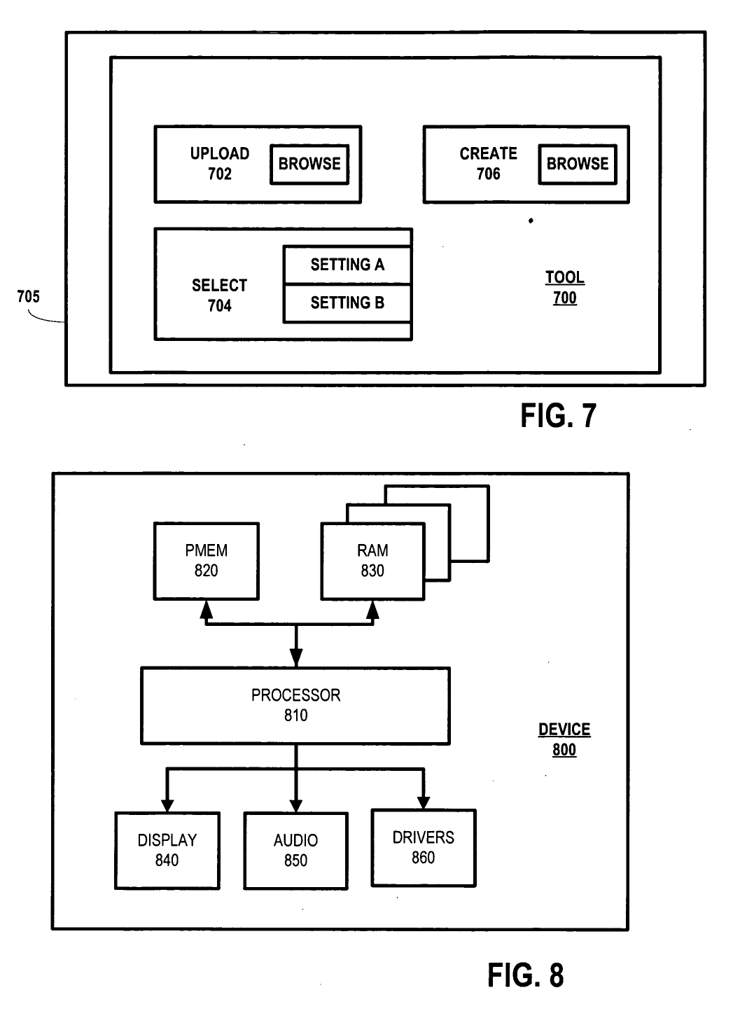

FIG. 4 illustrates a method in which customization data may be persistently loaded and used, under one embodiment of the invention. In step 410, customization data is identified. In one implementation, customization data is specified, designed or created by a source other than the manufacturer of the computing device, such as, for example, a reseller of the device or some other third party. Customization data for a particular set of computing devices may be in the form of, for example, a data file supplied by a third-party (e.g. a carrier) or created through input from the third party (see FIG. 7).

Step 420 provides that the customization data is written to a region of a persistent memory component (e.g. ROM component 310) that is independent of the operating system partition. This may correspond to an address range not in use by operating system data. As shown by, for example, an embodiment of FIG. 2, the region where the customization data is provided may correspond to an address block at the bottom of the persistent memory component, or an address back having another known reference.

Step 430 provides that a size of the customization data is identified when it is written to the persistent memory. According to one implementation, this step is performed by a programmatic element of the computing device and/or operating system.

In step 440, a value corresponding to the size of the customization data is stored with the operating system as a token. The token may be stored in a token area of the operating system. Many operating systems, such as the PALM OS and other manufactured for smaller computing devices, provide for the operating system to receive and store token values in its partition of the persistent memory.

At a time where the persistent memory holding the operating system and/or customization data is formatted, step 450 provides that the component that formats that portion of memory makes a determination as to the size of the free memory. This determination may include the amount of free memory less the operating system's partition and less the customization data size.

Step 460 provides that the identified free memory, which does not include an address range of the customization data, is formatted when the device is initiated from the hard-reset state. Given an implementation in which the customization data is written to the bottom of the portion of memory to be formatted, the result is that the customization data is unaffected by the structuring of the memory. All of the free memory (not including the operating system partition) but for the portion on which customization data is provided may be formatted in this step. The mount of free memory may be dependent on the size of the customization data. In one implementation, free memory is all memory that is not either in the operating system partition or used for storing the customization data. Variations exist, such as the amount of free memory being loosely dependent on the amount of customization data. For example, the free memory may correspond to the all memory that is not in the operating system partition less double the amount of memory needed to store the customization data.

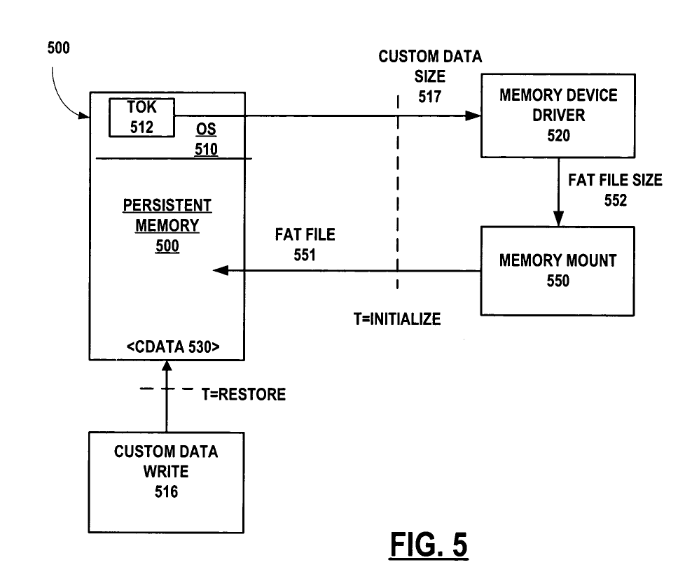

FIG. 5 illustrates a system for implementing an embodiment such as shown by FIG. 4. In FIG. 5, a system is provided to write customization data and into a persistent memory component 500. The system may be implemented on, for example, a mobile computing device employing a Flash memory component and a thin operating system (e.g. PALM OS). As with other examples, customization data may be specified or otherwise provided for or on behalf of a carrier or other third-party.

In an embodiment shown, memory component 500 partitions the operating system 510. At a time when the device is in a hard-reset state (T=HRESET), a custom data write process or module 516 writes customization data 530 into the memory component 500. A token 512 is created and stored with the operating system 510 that carries a value of the size of the customization data 530. As further described by other embodiments, one embodiment provides the customization data to be provided at an address range corresponding to the bottom of the memory component 500.

When the device is moved from the hard-reset state to an operational state (T=OPER), a memory device driver 540 accesses the partition of the operating system to read the value of the token 512. This value corresponds to a size of the customization data, and is referred to in FIG. 5 as customization data size. The memory device driver 540 communicates with a memory mounting module 550. The memory mounting module 550 performs functions that include formatting the memory component 500. In one embodiment, the memory mounting module 550 mounts FAT (File Access Table) files 551 onto the unused memory in the memory component 500. The amount of formatting that the memory mounting module 550 does is determined by the FAT File Size 552 provided from the memory device driver 540. The FAT File Size 552 value takes into account the presence of customization data 530. As part of an initialization process, immediately following the hard-reset state, the memory mount module 550 formats the persistent memory component 500 using the FAT File size 552, resulting in the customization data 530 being unaffected.

A system such as shown by FIG. 5 may be used to implement customization data, as well as update or rewrite customization data after it has already been implemented. Each of these activities may be performed without need to re-certify the operating system, as would be required, for example, if customization data was written to the operating system partition. Numerous scenarios are contemplated. For example, an imbalance may exist between the number of devices in different classes of customized devices. More specifically, for example, devices offered by one carrier or vendor may sell slower than the same device offered by another vendor, creating an imbalance in inventory of customized devices. According to an embodiment such as shown by FIG. 5, a device customized for particular vendor or carrier may be re-customized for another vendor carrier in order to move stale inventory. In a system such as shown by FIG. 5, the re-customization may be performed by creating the customization data and using the custom data write process or module 516, which overwrites existing customization data with new customization data. While the new customization data may have a different size, it may be provided at an address range that includes the bottom of the memory component. The size of the new customization data may be recorded with the token 512, which then uses the memory device driver to communicate the FAT File Size 552 (total memory less operating system partition less size of new customization data). At that point, the previous customization data is completely replaced with new customization data.

Numerous other situations exist in which customization data may be updated. When products become old in their lifecycle, embodiments described herein contemplate use of customization data to make devices more appealing. For example, one or more embodiments contemplate customizing devices at the end of their product cycles with discount vendors, and the customization data enables the devices to be sold more readily from such vendors.

As other example usages, customization data may be written or rewritten to provide novelty software designs, such celebrity art, collector editions, or collector item sequencing to make devices more unique, collectable or otherwise desirable.

By enabling customization data to be updatable, any application or bug fixes in customization data may readily be addressed, either by unshipped products in the product line, or by returned products. Customization data updates may be made to the persistent memory component with existing data already residing on it.

Customization Data Creation and Implementation

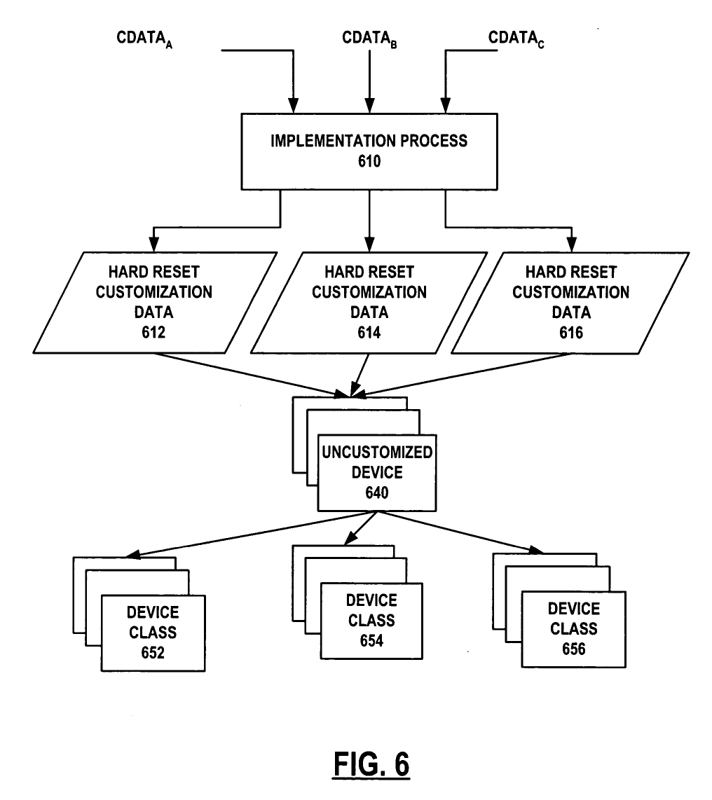

According to an embodiment, customization data is specified by input from parties that wish to customize a class, group or individual device from a production output of common devices. FIG. 6 illustrates a system by which customization data may be selected, specified and even created for use in customizing blank (un-customized) devices. In FIG. 6, a system includes an implementation process 610, which can receive inputs 602, 604 and 606 to generate corresponding custom data sets 612, 614 and 616. The custom data sets 612, 614 and 616 are for hard-resets.

In an example provided by FIG. 6, the inputs 602, 604 and 606 may originate from different sources and/or parties. For example, the implementation process 610 may receive customization inputs from designers through, for example, a web page, date transmission, data file, or manual entry. In one implementation, each resulting custom data set 612, 614 and 616 may be in the form of XML documents and/or data bits, representing applications, application data, data bits and other files.

As mentioned, one embodiment provides that the hard-reset customization data 612, 614 and 616 is formulated into XML files, executable files, and bitmap or binary data files. The XML data may include application data for applications that execute in the RAM when the computing device is in the operational state. Certain applications that are executed with the operating system, or even externally to the operating system, may have configurations that enable them to seek and pull customization data from the persistent memory component. Thus, one architecture for using customization data employs application pull mechanisms to incorporate customization data into the operations of one or more applications. Any customization data that is in bit form may include applications and images, including wall papers or software skins.

Once customization data sets 612, 614 and 616 are formulated, the different customization data sets may be implemented to classes of un-customized devices 640. The devices may be assumed to be un-customized, although as described with other embodiments, the customization data sets may be used to overwrite customized data already existing on a particular device. Furthermore, each customization data set 612, 614 and 616 may be paired with a quantity value indicating the number of devices that are to be customized by the particular data set. The quantity value may be included as part of the customization inputs 602, 604 and 606, or it may be determined from a separate source. The un-customized devices then become customized, once the customization data is implemented to modify the respective devices. In particular, a result of the implementation of the customization data is that the un-customized devices as a whole become customized into classes of devices, with each class representing a particular device with a particular customization data set. In FIG. 6, for example, each of class 652, class 654, and class 656 may represent devices from a particular vendor and/or offered with a particular service.

In particular, with wireless computing devices such as cellular phones or messaging devices, each device may be customized for retain in connection with wireless services offered by a particular wireless carrier. In this context, the customization data sets 612, 614 and 616 may represent any of the following: wall paper branded for a particular carrier, audio chimes and ring tones selected for default on a device (could be a brand as well), applications specific to a particular carrier (e.g. store locator for carrier), email configuration data for enabling a user to retrieve emails through default configuration data, default browser, default home page when the web browser is in use, and application data for applications that are provided in the operation system (e.g. contact records for the phone application).

According to an embodiment, the customization inputs 602, 604, and 606 may be provided by third-party designers. Such designers may include individuals selecting the customization design for a class of devices, or even end-users who wish to custom design their own personal device. FIG. 7 illustrates a graphic user-interface tool 700 for enabling design and creation of customization data sets 612, 614 and 616. The tool 700 may be web based, in that it can be accessed and used using a web browser, or alternatively, a web-based client. As such, the tool 700 may be rendered on a client terminal 705. The tool 700 enables a designer to (i) an upload feature 702 for enabling uploading of customization data, such as applications, images or sound files, (ii) selection tool 704 for enabling selection of certain data, such as settings (e.g. what time zone to assume the device will operate in), (iii) creation tool 706 for enabling creation of certain data, such as contact records. Other functions that can be performed through use of the tool 700 include (i) device selection (i.e. what device does the user wish to incorporate the customization data into), (ii) date by which the customization data is to take place, and (iii) quantity of devices that are to be customized in the particular manner. Various user-interface features, such as selection objects (icons and menus), text-entry fields, and check-boxes may be used to enable the user to make specifications and operate the tool 700.

While an embodiment described in detail with FIG. 6 and FIG. 7 contemplate customization data that is class-specific, other embodiments contemplate use of customization data when an individual user wishes to customize a particular device. Such customization data may be referred to as user-specific customization data. A user may specify, for example, a photo that is to form the wall paper of a device and available always on default setting. Furthermore, other embodiments contemplate retailers and resellers who wish to customize devices for a particular purpose. For example, a particular vendor may wish to customize a small selection of devices with the images of a celebrity or historical event, so that a computing device has a particular identification, ring tone or audio, wall paper or application. In each of the aforementioned examples, the tool 700 may be made available to the user as an individual or to the retailer or reseller.

The implementation process may include programmatic components to enable customization input to become customization data that can be loaded and stored in the persistent memory. In one embodiment, commercially available tools such as EDIT LIVE! FOR XML, manufactured by the EPHOX CORPORATION, may provide the tool 700 by which individuals may create the XML files and data maps that become the customization data stored on the device. Once generated, the customization data may be provided in the form of a file that can be “flashed” or downloaded into ROM. While embodiments contemplate such customization to take place at the point of manufacture, embodiments described herein enable the customizations to take place virtually at any point from manufacturing to retailing to use and to resell. For example, the retailer or user may use a program to upload select customization data into the ROM. In the PALM OS, a PRC file may be created to write customization data into ROM.

Hardware Diagram

FIG. 8 illustrates a simplified block diagram for use with one or more embodiments of the invention. A computing device 800 may include one or more processors 810, a persistent memory (such as a NAND Flash memory component) 820, one or more RAM memory 830, a display 840 (including software and hardware drivers), speakers or other audio output 850, and numerous other drivers. The block diagram illustrated by FIG. 8 may represent numerous types of devices, including cellular telephony devices, wireless messaging devices, or combination telephony/messaging devices. A computing device 800 may be utilized with any one or more embodiments or combination of embodiments described throughout this application. According to one embodiment, the processor 810 may read customization data from the persistent memory 820 when executing applications using RAM 830. The execution of applications may call customization data for use. Additionally, customization data may be used to create customized wallpaper and other images on the display 840, audio output (e.g. chimes and/or ring tones) from the audio output devices 850. Customization data may also drive or configure usage of other drivers 860 or other components that run from such drivers.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A component for a computing device, the component comprising:
a persistent memory configured to store, in a hard-reset state, data corresponding to an operating system, and customization data;
a first logic that delineates a first region of the persistent memory where the operating system is stored from a second region in the memory where the customization data is stored, so that the customization data is retrievable from the second region without retrieving data from the first region; and
a second logic that reserves a location of the second region where the customization data is stored, wherein the location is based on a size of the customization data.

2. The component of claim 1, wherein at least a portion of the second region excluding the customization data is capable of being formatted using the second logic when a computing device containing the memory component is initialized from the hard-reset state.

3. The component of claim 1, wherein the customization data is class-specific for the computing device.

4. The component of claim 1, wherein the customization data is user-specific for the computing device.

5. The component of claim 1, wherein the customization data includes binary data corresponding to at least one of an application or an image.

6. The component of claim 1, wherein the customization data includes application data for use with applications that are executing when the computing device that holds the memory component is in an operational state.

7. The component of claim 1, wherein the persistent memory is a Flash memory.

8. The component of claim 7, wherein the persistent memory is a NAND Flash memory.

9. The component of claim 1, wherein the customization data includes data sets corresponding to one or more of an application, application data, an image, or an audio file.

10. The component of claim 1, wherein the second logic includes a token that is stored with the operating system.

11. The component of claim 10, wherein the token identifies a value that indicates a size of the customization data.

12. The component of claim 1, wherein at least one of the first logic or second logic is stored in the persistent memory.

13. A computing device comprising:
a first memory that persistently holds data corresponding to (i) an operating system in a first region of the memory and (ii) a customization data in a second region of the first memory that does not overlap with the first region, wherein in a hard-reset state, the second region is substantially unformatted with exception of the customization data;
a first logic associated with the first memory to define the first region and the second region;
a value stored with the operating system that indicates at least a size of the customization data; and
a second logic associated with the first memory that is configured upon initialization from the hard-reset state, to format a section of the second memory that does not include a portion in which the customization data is provided, where the size of the section is determined at least in part on the value stored indicating the size of the customization data.

14. The computing device of claim 13, wherein the customization data is provided at a logical end of the persistent memory, so that the value stored identifies the location of the customization data in the memory.

15. The computing device of claim 13, further comprising:
a second memory configured to hold data when the computing device is in an operational state;
a third logic that transfers data corresponding to at least the operating system from the first memory to the second memory when the computing device is placed in the operational state from the hard-reset state.

16. The computing device of claim 15, wherein the first memory is configured to provide a store that backs up data in use with the second memory when the computing device is in the operational state.

17. The computing device of claim 15, wherein the second memory is configured to erase when the computing device is subjected to a reset event.

18. The computing device of claim 13, wherein the customization data includes data sets corresponding to one or more of (i) an application, (ii) application data, (iii) an image, (iv) or an audio file.

19. The computing device of claim 13, wherein the customization data is class-specific or user-specific.

20. The computing device of claim 13, wherein the customization data includes binary data corresponding to at least one of an application or an image.

20. A method for customizing a computing device, the method comprising: persistently storing the operating system in a first region of a memory of the computing device;
storing the customization data in a second region of the memory independently of the first region of the memory;
upon initialization of the computing device from a hard-reset state, formatting a portion of the second region that does not include the customization data for use with the computing device in the operational state;
wherein the portion of the second region that is formatted is based on a size of the customization data.

21. The method of claim 20, wherein formatting a portion of the second region that does not include the customization data includes sizing the portion of the second region by determining all of the second region less a portion of the second region where the customization data is provided. the second portion.

22. The method of claim 20, further comprising:
storing a value corresponding to the size of the customization data with the operating system; and
wherein formatting a portion of the second region that does not include the customization data includes using the value stored with the operating system to identify the portion of the second region containing the customization data.

23. The method of claim 22, wherein formatting a portion of the second region that does not include the customization data includes providing the customization data at a logical end of the second region, and sizing the portion of the second region that does not include the customization data using the value stored with the operating system.

24. A method for customizing a computing device, the method comprising:
upon initialization of the computing device from a hard-reset state, determining a size of a portion of a persistent memory of the computing device that is to be formatted, wherein the size is based on an amount of customization data that is stored in a region of the persistent memory that contains the portion to be formatted, and wherein the region of the persistent memory is independent of another persistent memory region where the operating system is stored; and
formatting the portion of the second memory without affecting the customization data.

25. The method of claim 24, further comprising storing in the persistent memory region, where the operating system is stored, a value based on the size of the customization data, and wherein determining a size of a portion of a persistent memory includes determining the size of that portion using the value stored in the persistent memory region.
